(19) United States
(12) Patent Application Publication
(10) Pub. No.: US 2011/0009781 A1
(43) Pub. Date: Jan. 13, 2011

(54) CHAIR-TYPE MASSAGE MACHINE

(75) Inventors: Junji Nakamura, Hikone (JP); Munekiyo Ikebe, Hikone (JP); Masatoshi Dairin, Hikone (JP); Yousuke Kurata, Hikone (JP)

Correspondence Address: GREENBLUM & BERNSTEIN, P.L.C., 1950 ROLAND CLARKE PLACE, RESTON, VA, 20191, US

(73) Assignee: PANASONIC ELECTRIC WORKS CO., LTD., Osaka (JP)

(21) Appl. No.: 12/673,621

(22) PCT Filed: Aug. 5, 2008
(86) PCT No.: PCT/JP2008/063994

§ 371 Date: Feb. 16, 2010

(30) Foreign Application Priority Data
Aug. 30, 2007 (JP) 2007-224469

(51) Int. Cl. A61H 15/00

(52) U.S. Cl. 601/115

(57) ABSTRACT

A chair-type massage machine has a seat, a backrest part, and a treatment mechanism that is provided in the backrest part so as to able to move up and down, and the treatment mechanism comprises: a treatment arm having a treatment element at substantially a tip end thereof; a massage power selection mechanism for adjusting massage strength by displacing the treatment arm between a weak state in which the treatment arm is substantially parallel to a backrest face of the backrest part and a strong state in which the treatment arm is erected substantially perpendicular to the backrest face; and a push-out member that is provided closer to a base end side than the treatment element of the treatment arm and is positioned below the treatment element when the treatment arm is in the strong state.

### TECHNICAL FIELD

The present invention relates to a chair-type massage machine in which a backrest thereof is embedded with a treatment mechanism capable of moving up and down, and a treatment element provided at substantially a tip end of a treatment arm of the treatment mechanism massages the back of a treated person by swinging the treatment arm.

### BACKGROUND ART

As the abovementioned chair-type massage machine in which the backrest is embedded with the treatment mechanism capable of moving up and down, there is a chair-type massage machine in which treatment elements that are provided at substantial tip ends of a pair of left and right treatment arms of the treatment mechanism apply a kneading massage, tapping massage or other treatment to the back of a treated person by causing the pair of treatment arms to swing in the cross direction, forward/backward, or in the vertical direction. In such a chair-type massage machine, a massage power selection mechanism of the treatment mechanism is generally configured such that the massage strength can be adjusted by erecting the treatment arms from a substantially parallel to a substantially perpendicular orientation with respect to the backrest face. When such a treatment mechanism returns to its home position (the position of the lower back of the sitting treated person), the treatment arms are placed in the substantially parallel orientation with respect to the backrest face (that is, the treatment elements are retracted to the backrest side), and thereafter the treatment mechanism is dropped.

However, when some sort of abnormality drops the treatment mechanism while the massage power is in a strong state where the treatment elements provided in the treatment arms project from the backrest face, the treated person might be caught between the treatment arms provided with the treatment elements and the seat.

For example, as shown in FIG. 12A, when a treated person 1 is well-built and has a thick upper body, the top P of one of his/her shoulder is positioned forward of a treatment element 2 composed of a massage ball or the like. In this case, the treatment element 2 pushes a shoulder 1a of the treated person 1 from the back to the front as a treatment mechanism 3 descends, preventing the treated person 1 from being caught as described above.

On the other hand, as shown in FIG. 12B, when the treated person 1 is an elderly person or a child with a thin upper body, the treatment element 2 is positioned in front of the top P of the shoulder 1a of the treated person 1. In this case, because the treatment element 2 draws the treated person 1 toward a backrest part 4 side, the treated person 1 gets caught between a treatment arm provided with the treatment element and the seat as the treatment mechanism 3 descends.

Therefore, in Patent Document 1, in the case where the upper and lower limit switches are not activated even after a predetermined time period elapses since the start of a vertical operation of the treatment mechanism, it is determined that the treated person or a foreign matter is caught as described above, and consequently an abnormality is informed. Moreover, in Patent Document 2, the vertical operation is restricted when a combination of a sitting sensor detecting the presence/absence of the lower body of a treated person and a pressurization sensor detecting the presence/absence of the upper body detect that the seating state is not normal, so that the treated person is prevented from being caught as described above.

However, the problem of the conventional technology of Patent Document 1 is that the treated person cannot be prevented from being caught as described above, because the conventional technology of Patent Document 1 only has the function of reporting the abnormality after the treated person is already caught. The problem of Patent Document 2 is that the control is complicated because it is necessary to determine whether the body types or various seating states are normal or abnormal.

Patent Document 1: Japanese Patent Application Laid-open No. H8-80329

### Patent Document 2: Japanese Patent Application Laid-open No. 2006-149417

### DISCLOSURE OF THE INVENTION

An object of the present invention is to provide a chair-type massage machine that is capable of reliably preventing a treated person from being caught between a treatment element and a seating face as the treatment mechanism descends, without using a complex configuration.

A chair-type massage machine according to one aspect of the present invention is a chair-type massage machine having a seat, a backrest part, and a treatment mechanism that is provided in the backrest part so as to able to move up and down, wherein the treatment mechanism has a treatment arm having a treatment element at substantially a tip end thereof, a massage power selection mechanism for adjusting massage strength by displacing the treatment arm between a weak state in which the treatment arm is substantially parallel to a backrest face of the backrest part and a strong state in which the treatment arm is erected substantially perpendicular to the backrest face, and a push-out member that is provided closer to a base end side than the treatment element of the treatment arm and is positioned below the treatment element when the treatment arm is in the strong state.

According to the configuration above, when an abnormality occurs where the treatment mechanism descends while the treatment arm is in the strong state where the treatment element projects from the backrest face, the push-out member pushes a shoulder of the treated person from the back to the front even when the treatment element is positioned forward of the top of the shoulder of the treated person. Therefore, even when a treated person sitting on the seat is an elderly person or a child with a thin upper body (that is, even when the treatment element is positioned in front of the top of the shoulder of the treated person), the treated person can be reliably prevented from being caught between a seating face and the treatment element as the treatment mechanism descends. In addition, because the treated person can be mechanically prevented from being caught therebetween without using a sensor or other electrical configuration, a complex configuration is not required.

The object, characteristics and advantages of the present invention will become clear by the following detailed description and the accompanying drawings.

### BRIEF DESCRIPTION OF THE DRAWINGS

FIG. 1 is a perspective view of a massage machine according to an embodiment of the present invention.

FIG. 2 is a side view of the massage machine shown in FIG. 1.

FIGS. 3A and 3B are each a perspective view in which a treatment mechanism of the massage machine of FIG. 1 is viewed from the front side.

FIG. 4 is a perspective view in which the treatment mechanism is viewed from the back side.

FIGS. 5A and 5B are each a side view of the treatment mechanism.

FIG. 6 is a perspective view in which a treatment element assembly inside the treatment mechanism is removed.

FIG. 7 is a side view for explaining an operation of the treatment element assembly.

FIG. 8 is a side view of the treatment mechanism for explaining the positional relationship between a treatment element and a push-out member.

FIG. 9 is a diagram for explaining a treated person pushing operation performed by the push-out member.

FIG. 10 is a perspective view in which a treatment element assembly of another embodiment of the present invention.

FIGS. 11A and 11B are each a perspective view of a treatment arm of the treatment element assembly shown in FIG. 10.

FIGS. 12A and 12B are each an explanatory diagram for explaining the problems of the conventional massage machine.

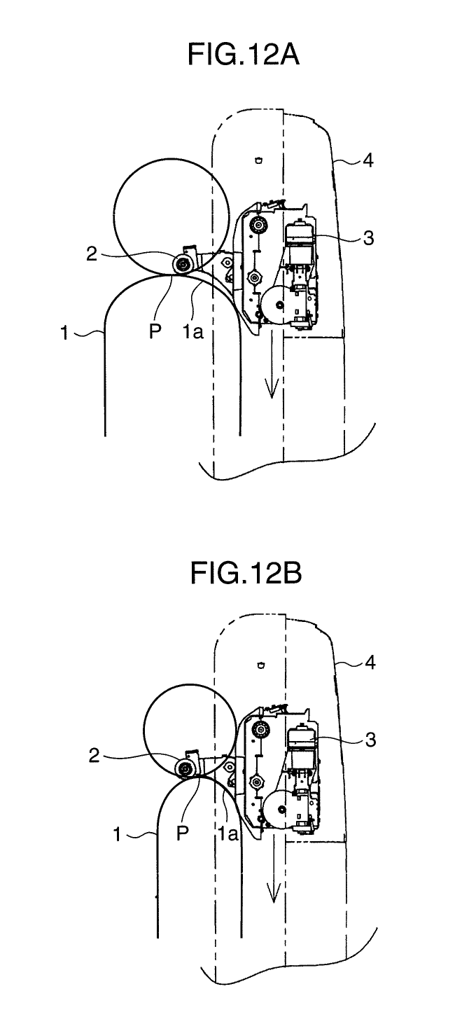

### BEST MODE FOR CARRYING OUT THE INVENTION

### Embodiment 1

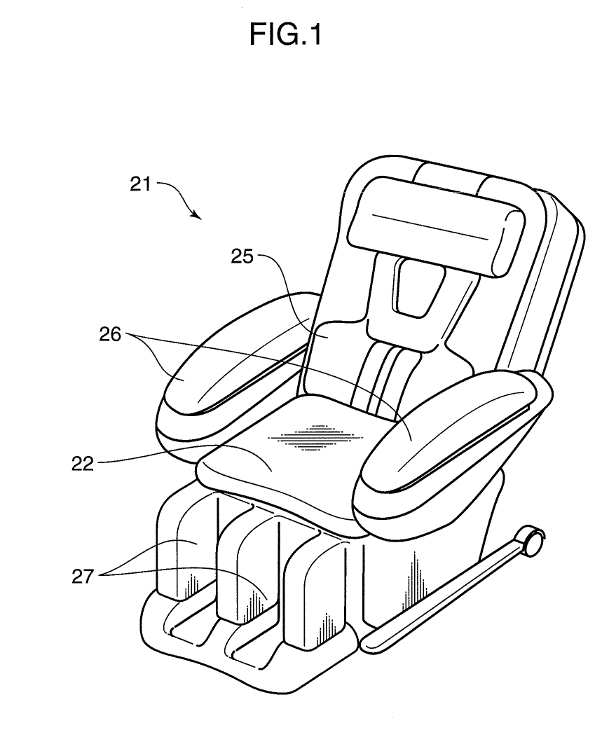

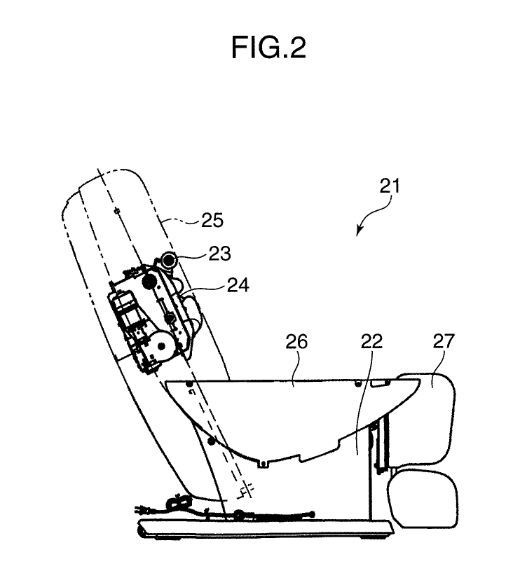

FIG. 1 is a perspective view of a chair-type massage machine 21 according to an embodiment of the present invention, and FIG. 2 is a side view thereof. This massage machine 21 is configured by a seat 22 on which a treated person sits, a backrest part 25 that is embedded with a treatment mechanism 24 having a below-described treatment element 23 for massaging an upper body, the treatment element 23 being described hereinafter, armrest parts 26, and footrest parts 27 that have airbags for massaging lower legs. Note that some configurations such as an operation panel are omitted.

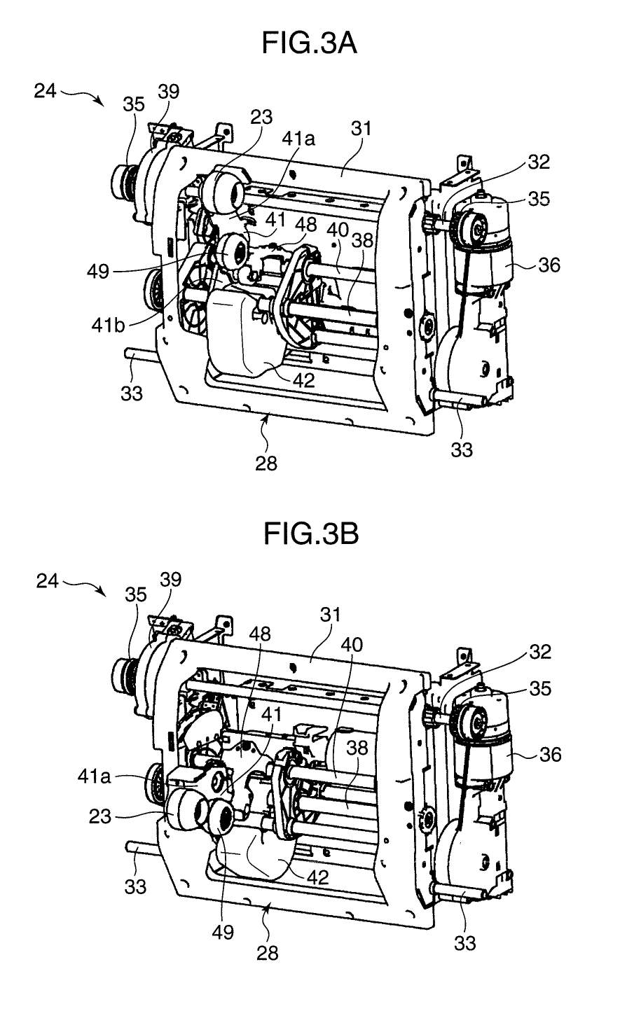

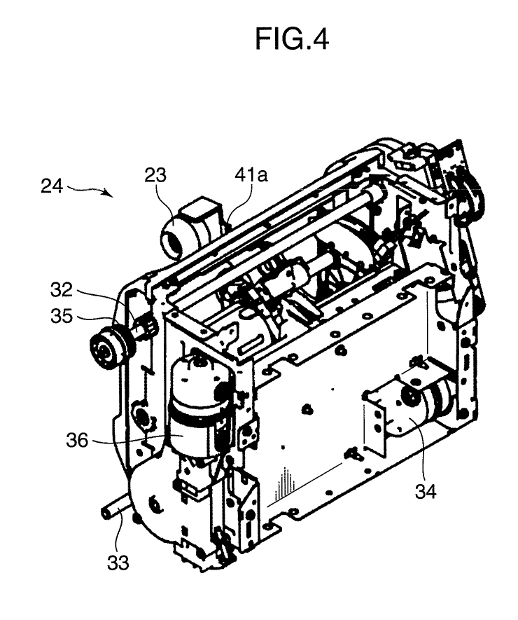

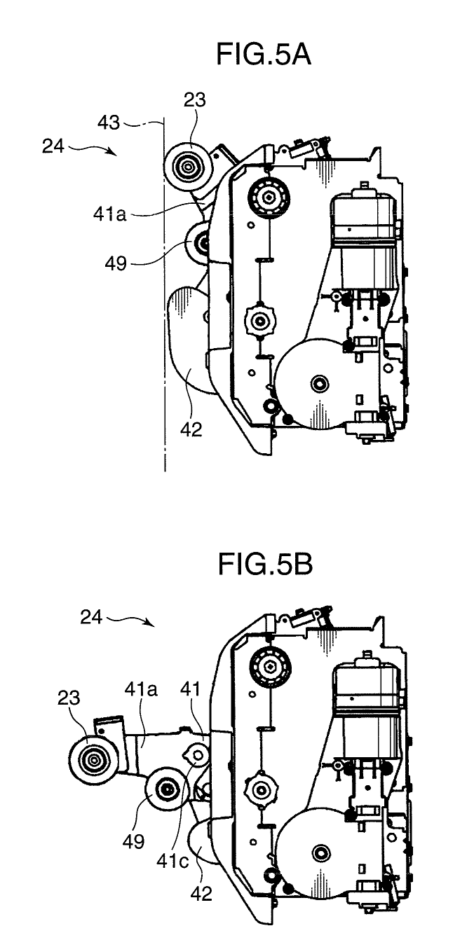

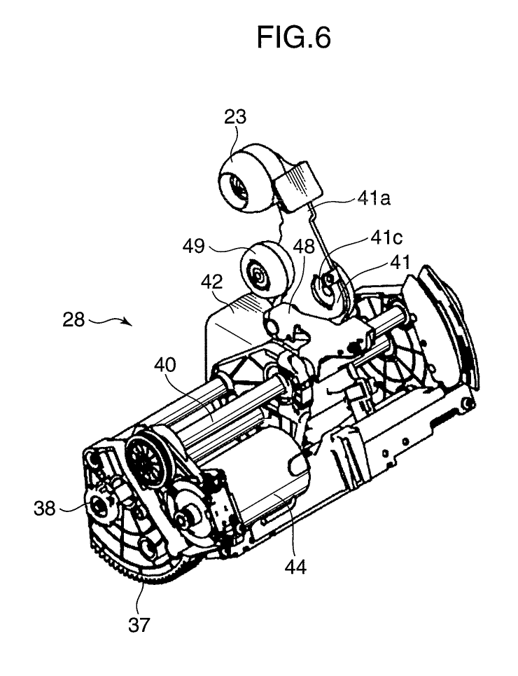

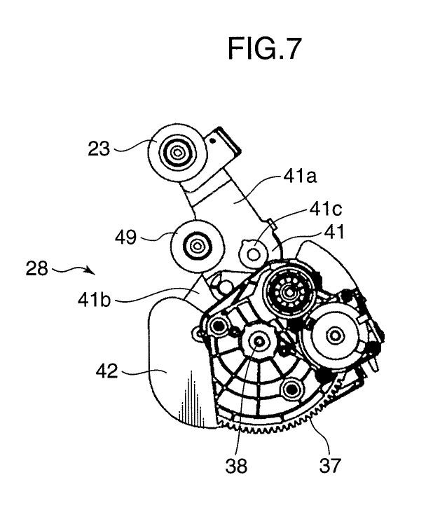

FIGS. 3A to 7 are diagrams for explaining the treatment mechanism 24 in detail. FIG. 3A is a perspective view in which the treatment mechanism (weak state) of the massage machine of FIG. 1 is viewed from the front side. FIG. 3B is a perspective view in which the treatment mechanism (strong state) of the massage machine of FIG. 1 is viewed from the front side. FIG. 4 is a perspective view in which the treatment mechanism 24 is viewed from the back side. FIG. 5A is a side view of the treatment mechanism (weak state). FIG. 5B is a side view of the treatment mechanism (strong state). FIG. 6 is a perspective view of a treatment element assembly 28 inside the treatment mechanism 24, and FIG. 7 is a side view thereof. Note that the treatment element 23 is configured as a pair of left and right treatment elements. In these diagrams, however, for the convenience of explanation (for the sake of easier understanding of the diagrams illustrating the treatment mechanism 24), only the right-hand treatment element is shown and the illustration of the left-hand treatment element symmetrical to the right-hand treatment element is omitted.

A pair of left and right axes, a drive axis 32 and a guide axis 33, projects from a main body frame 31 of the treatment mechanism 24. These axes slide within an unshown guide groove that is laid within the backrest part 25, whereby the treatment mechanism 24 can be moved up and down in the vertical direction. Moreover, a gear 35 that is engaged with an unshown rack rail laid within the backrest part 25 is attached to the drive axis 32. When a motor (hidden in the diagrams) installed on the right side of the main body frame 31 rotates, a worm and its gear stored in a gear box 39 are rotated, and the power is transmitted to the gear 35 via the drive axis 32. As a result of this power transmission to the gear 35, the treatment mechanism 24 shifts up and down in the vertical direction within the backrest part 25 so that height adjustment and back straightening can be achieved.

The treatment element assembly 28 is stored in the main body frame 31. By rotating a motor 36 provided on the side of the main body frame 31, the drive force of the motor 36 is transmitted to a gear 37 shown by an unshown gear mechanism, and the treatment element assembly 28 supported in the main body frame 31 swings freely around an axis 38. The treatment element 23 is composed of a massage ball having an elastic surface, and is rotatably and pivotally supported to one end of a treatment arm 41 that is in a substantially V-shape as viewed from the side. A support member 42 made of resin, which supports the back of the treated person by means of a rough plane, is attached to the other end of the treatment arm 41 under the treatment element 23. As the treatment arm 41 rotates around the axis 38 provided in substantially the center of the treatment art 41, a section 41a of the treatment arm 41 near the treatment element 23 can be erected from a substantially parallel orientation with the backrest face of the backrest part 25 as shown in FIGS. 3A and 5A to a substantially perpendicular orientation with respect to the backrest face of the backrest part 25 as shown in FIGS. 3B and 5B. The massage strength can be adjusted in this manner. The motor 36, the gear mechanism, the axis 38 and the like configure a massage power selection mechanism.

By allowing the support member 42 to retract to the inside of the treatment mechanism 24 in a seesaw manner in conjunction with the projection of the treatment element 23 from the backrest part 25, the quantity of power can be made larger than when the support member 42 is fixed. Therefore, in the strong mode in which the section 41a of the treatment arm 41 is substantially perpendicular to the backrest face of the backrest part 25, only the treatment element 23 can be brought into contact with the back of the treated person to apply a strong, stimulating massage, and especially a large massage effect can be obtained in the range between the shoulders and neck of the treated person.

On the other hand, in the weak mode in which the section 41a of the treatment arm 41 is substantially in parallel to the backrest part 25, both the treatment element 23 and the support member 42 come into contact with the back of the treated person. Moreover, in the weak mode, because supporting surfaces of the treatment element 23 and the support member 42 are located in substantially the same place (a line 43 connecting the treatment element 23 with the support member 42 is substantially parallel to the backrest part 25, as shown in FIG. 5A), no discomfort is caused by unevenness of the back of the treated person, and soft (less stimulating) touch can be applied to treat the back of the treated person. Additionally, when moving the treatment mechanism 24 up and down for adjusting the height or the like, local support by the treatment element 23 can cause pain, but such a trouble can be prevented by applying support using a substantially flat surface of the support member 42. Furthermore, because the support member 42 is not in the shape of a roller, the contact area thereof for supporting the treated person can be increased without forcibly increasing the number of components.

On the other hand, in the substantially V-shaped treatment arm 41, the section 41a on the treatment element 23 side and a section 41b on the support member 42 side are coupled to each other by a node 41c so that they can be displaced for opening and closing. When a motor 44 installed in the treatment element assembly 28 is rotated, an eccentric shaft 40 whose phase varies between the right and left side by 180° is rotated in the form of a crankshaft via unshown gear or the like. Consequently, a link 48 attached to the eccentric shaft 40 swings on the side opposite to the treatment element 23 of the section 41a of the treatment arm 41, whereby the pair of left and right treatment elements 23 performs the tapping massage. Moreover, by rotating a motor 34 installed in the lower part of the main body frame 31 (see FIG. 4), the horizontal space between the pair of left and right treatment arms 41 synchronously with each other, whereby the pair of left and right treatment elements 23 perform the kneading massage on the treated person.

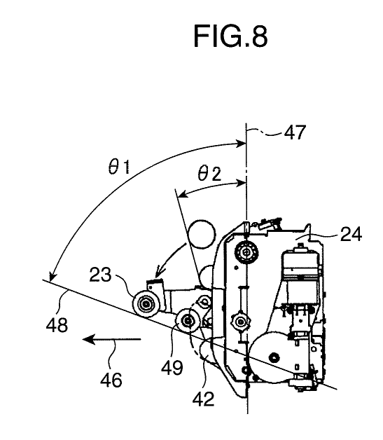

It should be noted that, in the present embodiment, the massage machine 1 configured as described above is provided with a push-out member 49 which is positioned closer to the base end side of the treatment arm 41 than the treatment element 23, and is positioned also below the treatment element 23 in the strong state in which the section 41a of the treatment arm 41 is erected substantially perpendicular to the backrest face of the backrest part 25 as shown in FIGS. 3A and 5B. Specifically, as shown in FIG. 8, the angle θ1, θ2 or the like between a line 47 formed by the vertical movement of the treatment mechanism 24 and a tangential line 48 connecting the roller surfaces of the treatment element 23 and of the push-out member 49 is less than 90°. In this manner, the push-out member 49 is constantly positioned below the treatment element 23.

Next is described an operation of the massage machine 21 performed upon erroneous detection, such that a treated person 45 is not seated, or when the treatment mechanism 24 is dropped during the strong state where the treatment element 23 projects from the backrest part 25, due to abnormalities of a control microcomputer.

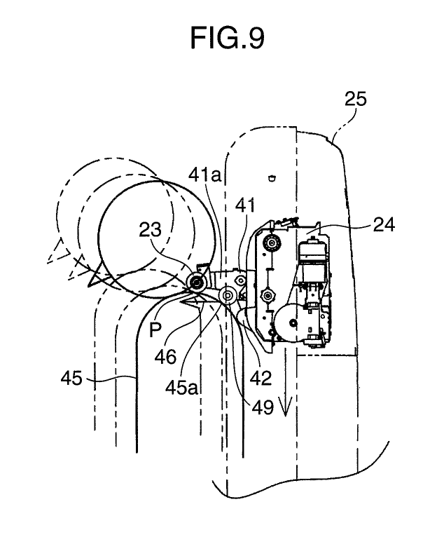

In this case, even when the treatment element 23 is positioned forward of the top of a shoulder of the treated person 45, the push-out member 49 pushes a shoulder 45a of the treated person 45 from the back to the front, as shown by the arrow 46 in FIG. 9. Therefore, even the treated person 45 with a thin upper body such as an elderly person or a child sits in the massage machine 21 and when the treatment element 23 composed of a massage ball is positioned forward of the top P of the shoulder 45a of the treated person 45, the treated person 45 can be reliably prevented from being caught between the seat 22 and the treatment element 23 as the treatment mechanism 24 descends. In addition, because the treated person 45 can be mechanically prevented from being caught therebetween without using a sensor or other electrical configuration, a complex configuration is not required.

In a weak position in which the section 41a of the treatment arm 41 is substantially parallel to the backrest face of the backrest part 25 so that the treated person 45 is prevented from being caught as described above, the push-out member 49 is positioned rearward of the tangential line 43 of the treatment element 23 and the support member 42, as shown in FIG. 5A. Thus, the push-out member 49 no longer comes into contact with the treated person 45 to become an obstacle to the treatment, whereby a comfortable massage can be provided to the treated person 45.

It should be noted that the push-out member 49 is formed into a rotatable roller, as with the treatment element 23. This way, the fabric of the backrest part 25 can be prevented from being stuck or entangled into the push-out member 49.

It should also be noted that the roller surface of the push-out member 49 is composed of an elastic body. The treatment element 23 and the push-out member 49 are both configured by covering a cylinder made of a rigid material, with the abovementioned elastic body in the form of a cylinder, fitting the cylinder into a pin provided in the treatment arm 41, and thereafter retaining the tip end of the pin. Therefore, as with the case of the treatment operation performed by the treatment element 23, the shoulder 45a of the treated person 45 is not damaged by the pushing operation of the push-out member 49.

### Embodiment 2

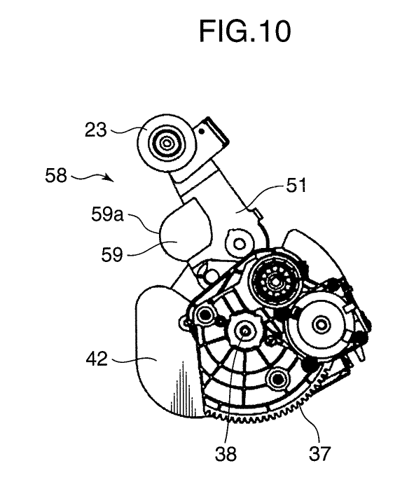

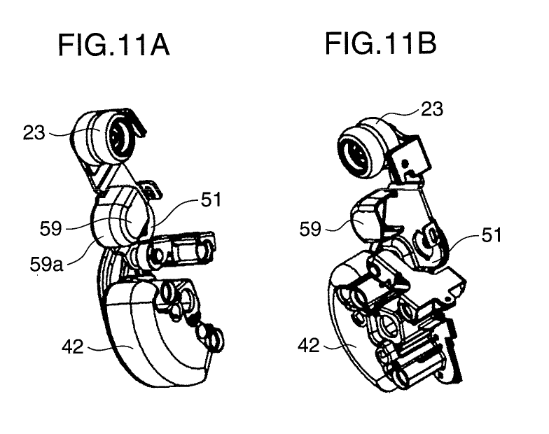

FIG. 10 is a perspective view of a treatment element assembly 58 according to another embodiment of the present invention. FIG. 11A is a perspective view in which a treatment arm of the treatment element assembly shown in FIG. 10 is viewed from the front side. FIG. 11B is a perspective view in which the treatment arm of the treatment element assembly shown in FIG. 10 is viewed from the back side. As with FIG. 7, in FIG. 10 the same reference numerals are applied to the corresponding sections, and the description thereof is omitted accordingly.

It should be noted that a push-out member 59 of this treatment arm 51 is composed of a resin molding. In other words, the push-out member 59 with a simpler structure is used in place of the push-out member 49 configured by a roller. It is desired that this push-out member 59 is integrally molded with the treatment arm 51, in order to simplify the production process and cut the production cost. Additionally, the push-out member 59 is made of a material that has a surface 59a sliding smoothly on the fabric of the backrest part 25, or is applied with finishing touches. The push-out member 59 is also formed into a hollow shape and is thereby elastically deformable as shown in FIG. 11B, so that the shoulder 45a of the treated person 45 is not damaged.

Even with this configuration, the treated person 45 can be mechanically prevented from being caught as described above, without using a complex configuration.

Note that the specific embodiment described above mainly includes the invention configured as described hereinafter.

A chair-type massage machine according to one aspect of the present invention is a chair-type massage machine having a seat, a backrest part, and a treatment mechanism that is provided in the backrest part so as to able to move up and down, wherein the treatment mechanism has a treatment arm having a treatment element at substantially a tip end thereof, a massage power selection mechanism that adjusts massage strength by displacing the treatment arm between a weak state in which the treatment arm is substantially parallel to a backrest face of the backrest part and a strong state in which the treatment arm is erected substantially perpendicular to the backrest face, and a push-out member that is provided closer to a base end side than the treatment element of the treatment arm and is positioned below the treatment element when the treatment arm is in the strong state.

According to the configuration above, when an abnormality occurs where the treatment mechanism descends while the treatment arm is in the strong state where the treatment element projects from the backrest face, the push-out member pushes a shoulder of the treated person from the back to the front even when the treatment element is positioned forward of the top of the shoulder of the treated person. Therefore, even when a treated person sitting on the seat is an elderly person or a child with a thin upper body (that is, even when the treatment element is positioned in front of the top of the shoulder of the treated person), the treated person can be reliably prevented from being caught between a seating face and the treatment element as the treatment mechanism descends. In addition, because the treated person can be mechanically prevented from being caught therebetween without using a sensor or other electrical configuration, a complex configuration is not required.

It is desired in the above-described configuration that the push-out member be in the shape of a rotatable roller.

As a result, the effect of preventing the fabric of the backrest from being stuck or entangled into the push-out member can be accomplished.

Moreover, in the configuration above, it is desired that the roller surface of the push-out member be configured by an elastic body.

In this manner, when the treated person is pushed out by the push-out member, the effect of pushing out can be accomplished without damaging the shoulders of the treated person.

In the configuration above, it is desired that the treatment mechanism include a support member that supports the back of the treated person by means of a substantially flat surface below the treatment element, when the treatment arm is in the weak state.

Thus, when the treatment arm is in the weak state, a soft (less stimulating) treatment can be applied by applying support using the substantially flat surface of the support member.

Furthermore, in the configuration above, it is desired that the push-out member be positioned rearward of a tangential line of the treatment element and the support member when the treatment arm is in the weak state.

In this manner, in the weak state in which the treated person is not caught as described above, the push-out member no longer comes into contact with the treated person to become an obstacle to the treatment, whereby the effect of providing a comfortable massage to the treated person can be achieved.

In the configuration described above, it is desired that the treatment arm be in a substantially V-shape in which substantially the center thereof is rotatably and pivotally supported, that one end of the treatment arm be provided with the treatment element, while the other end thereof be provided with the support member, and that, when the treatment arm is rotated and displaced from the weak state to the strong state, the support member be retracted to the inside of the treatment mechanism in conjunction with the rotation of the treatment arm.

By adopting the configuration in which the support member is retracted to the inside of the treatment mechanism in conjunction with the displacement of the treatment arm to the strong state as described above, the structure for displacing the support member can be simplified.

In the configuration above, it is desired that the push-out member be composed of a resin molding.

Because the structure can be simplified in the manner described above, the effect of cutting the production cost can be achieved.

In the configuration above, it is desired that the push-out member be molded integrally with the treatment arm.

Accordingly, the effect of simplifying the production process and cutting the production cost can be realized.

Moreover, in the configuration above, it is desired that the push-out member be formed into a hollow shape so as to be elastically deformable.

Consequently, the effect of preventing the shoulders of the treated person from being damaged by the push-out member can be accomplished.

The specific embodiments or examples that are presented in the detailed description of the present invention are merely for clarifying the technical contents of the present invention. Therefore, the present invention should not be construed as limited to these specific examples. The present invention can be implemented in numerous different ways without departing from the spirit of the present invention and the scope of the patent claims described hereinafter.

1. A chair-type massage machine having a seat, a backrest part, and a treatment mechanism that is provided in the backrest part so as to able to move up and down, wherein the treatment mechanism comprises:
a treatment arm having a treatment element at substantially a tip end thereof;
a massage power selection mechanism for adjusting massage strength by displacing the treatment arm between a weak state in which the treatment arm is substantially parallel to a backrest face of the backrest part and a strong state in which the treatment arm is erected substantially perpendicular to the backrest face; and
a push-out member that is provided closer to a base end side than the treatment element of the treatment arm and is positioned below the treatment element when the treatment arm is in the strong state.

2. The chair-type massage machine according to claim 1, wherein the push-out member is in the form of a rotatable roller.

3. The chair-type massage machine according to claim 2, wherein a roller surface of the push-out member is composed of an elastic body.

4. The chair-type massage machine according to claim 1, wherein the treatment mechanism has a support member that supports the back of a treated person by means of a substantially flat surface below the treatment element when the treatment arm is in the weak state.

5. The chair-type massage machine according to claim 4, wherein the push-out member is positioned rearward of a tangential line of the treatment element and the support member when the treatment arm is in the weak state.

6. The chair-type massage machine according to claim 5, wherein the treatment arm is in a substantially V-shape in which substantially a center thereof is rotatably and pivotally supported, one end of the treatment arm is provided with the treatment element, while the other end thereof is provided with the support member, and when the treatment arm is rotated and displaced from the weak state to the strong state, the support member is retracted to the inside of the treatment mechanism in conjunction with the rotation of the treatment arm.

7. The chair-type massage machine according to claim 1, wherein the push-out part is composed of a resin molding.

8. The chair-type massage machine according to claim 7, wherein the push-out member is molded integrally with the treatment arm.

9. The chair-type massage machine according to claim 7, wherein the push-out member is formed into a hollow shape so as to be elastically deformable.
